(19) United States
(12) Patent Application Publication
(10) Pub. No.: US 2025/0111171 A1
(43) Pub. Date: Apr. 3, 2025

(54) REDUCING LATENCY IN GAME CHAT TRANSLATION

(71) Applicant: Sony Interactive Entertainment Inc., Tokyo (JP)

(72) Inventors: Jon Brelin, San Mateo, CA (US); Rathish Krishnan, San Mateo, CA (US); Jason Wang, San Mateo, CA (US); Deepali Arya, San Mateo, CA (US); Hung-Ju Lee, San Mateo, CA (US)

(21) Appl. No.: 18/478,272

(22) Filed: Sep. 29, 2023

(51) Int. Cl. G06F 40/58; G06F 40/263; G06F 40/47

(52) U.S. Cl. CPC G06F 40/58; G06F 40/263; G06F 40/47

(57) ABSTRACT

Techniques are described for translating computer game chat to a different language for a partner gamer. If the chat is determined to be related to a game being played as opposed to social chat, a glossary may be used tailored to that game to first determine if a spoken term is in the glossary. If it is, a lookup of an equivalent term from the glossary can be used instead of passing the term through a translation engine, increasing accuracy and saving translation time.

### FIELD

The present application relates to technically inventive, non-routine solutions that are necessarily rooted in computer technology and that produce concrete technical improvements, and more specifically to reducing latency in game chat translation.

### BACKGROUND

When playing computer games, players often enjoy chatting with each other about the game itself or simple social chat. As understood herein, language translation may be required if two players speak different languages.

### SUMMARY

As further understood herein, translation of chat may introduce latency into communication between two players, which is particularly nettlesome if the players happen to be communicating about cooperation as a team in the game.

Accordingly, an apparatus includes at least one processor assembly configured to receive, from a sender input device, chat in a first language. Under at least a first condition and responsive to a first term in the chat being in a glossary associated with a computer game, the processor assembly is configured to look up a term in a second language from the glossary corresponding to the first term. Responsive to a second term in the chat not being in the glossary, the processor assembly is configured to provide the second term to a translation engine to output a term in the second language corresponding to the second term, and send the term in the second language from the glossary corresponding to the first term and the term in the second language corresponding to the second term to a recipient output device for presentation thereof.

In some embodiments the first condition is that the chat pertains to the computer game associated with the glossary. The processor assembly may be configured to not look up the first term in the glossary responsive to the chat not pertaining to the computer game associated with the glossary and provide the first term to the translation engine.

In example implementations the processor assembly may be configured to, under at least the first condition, responsive to a third term in the chat being in the glossary and being a non-language term or proper noun associated with the computer game, send the third term unchanged to the recipient output device.

The recipient output device and sender input device can communicate with each other over a wide area computer network.

In non-limiting examples the processor assembly may be configured to provide the term in the second language from the glossary corresponding to the first term to the translation engine, or provide an indication of the part of speech of the term in the second language from the glossary corresponding to the first term to the translation engine, or both provide the term in the second language from the glossary corresponding to the first term to the translation engine and provide an indication of the part of speech of the term in the second language from the glossary corresponding to the first term to the translation engine. In this way the translation engine is enabled to maintain context.

If desired, the processor assembly can be configured to identify the first and second languages. In some implementations the glossary is a first glossary and the chat is received during a first scene of the computer game, and the processor assembly is configured to use a second glossary responsive to the computer game presenting a second scene. The first glossary thus is associated with terms in the first scene and the second glossary is associated with terms in the second scene.

In another aspect, an apparatus includes at least one computer medium that is not a transitory signal and that in turn includes instructions executable by at least one processor assembly to translate first terms in chat in a first language and input during play of a computer game to second terms in a second language using a translation engine. The instructions also are executable to look up third terms in the chat in the first language using a glossary to correlate the third terms to fourth terms in the second language, and send the second and fourth terms on an output device for presentation thereof.

In another aspect, a method includes receiving chat during play of a computer game and input by means of at least one input device. The chat is in a first language, and the method includes translating first terms in the chat to terms in a second language using a translation engine and also using second terms in the chat to look up terms in the second language using at least one glossary. The method includes sending the terms in the second language obtained from the translation engine and the glossary to at least one output device.

The details of the present disclosure, both as to its structure and operation, can be best understood in reference to the accompanying drawings, in which like reference numerals refer to like parts, and in which:

### BRIEF DESCRIPTION OF THE DRAWINGS

FIG. 1 is a block diagram of an example system including an example in consistent with present principles;

FIG. 2 illustrates an example encoder/decoder system;

FIG. 3 illustrates two game players chatting with each other;

FIG. 4 illustrates three example machine learning (ML) models that can be used for present purposes;

FIG. 5 illustrates example logic in example flow chart format for training the social chat model;

FIG. 6 illustrates example logic in example flow chart format for training the game chat model;

FIG. 7 illustrates example logic in example flow chart format for training the selection model;

FIG. 8 illustrates example logic in example flow chart format for identifying a glossary to use;

FIG. 9 illustrates example logic in example flow chart format for using both a glossary and a translation engine to convert chat in one language into a second language;

FIG. 10 schematically illustrates a glossary set; and

FIG. 11 illustrates example logic in example flow chart format for training a machine learning (ML) model to generate a glossary.

### DETAILED DESCRIPTION

This disclosure relates generally to computer ecosystems including aspects of consumer electronics (CE) device networks such as but not limited to computer game networks. A system herein may include server and client components which may be connected over a network such that data may be exchanged between the client and server components. The client components may include one or more computing devices including game consoles such as Sony PlayStation® or a game console made by Microsoft or Nintendo or other manufacturer, extended reality (XR) headsets such as virtual reality (VR) headsets, augmented reality (AR) headsets, portable televisions (e.g., smart TVs, Internet-enabled TVs), portable computers such as laptops and tablet computers, and other mobile devices including smart phones and additional examples discussed below. These client devices may operate with a variety of operating environments. For example, some of the client computers may employ, as examples, Linux operating systems, operating systems from Microsoft, or a Unix operating system, or operating systems produced by Apple, Inc., or Google, or a Berkeley Software Distribution or Berkeley Standard Distribution (BSD) OS including descendants of BSD. These operating environments may be used to execute one or more browsing programs, such as a browser made by Microsoft or Google or Mozilla or other browser program that can access websites hosted by the Internet servers discussed below. Also, an operating environment according to present principles may be used to execute one or more computer game programs.

Servers and/or gateways may be used that may include one or more processors executing instructions that configure the servers to receive and transmit data over a network such as the Internet. Or a client and server can be connected over a local intranet or a virtual private network. A server or controller may be instantiated by a game console such as a Sony PlayStation®, a personal computer, etc.

Information may be exchanged over a network between the clients and servers. To this end and for security, servers and/or clients can include firewalls, load balancers, temporary storages, and proxies, and other network infrastructure for reliability and security. One or more servers may form an apparatus that implement methods of providing a secure community such as an online social website or gamer network to network members.

A processor may be a single-or multi-chip processor that can execute logic by means of various lines such as address lines, data lines, and control lines and registers and shift registers. A processor including a digital signal processor (DSP) may be an embodiment of circuitry. A processor assembly may include one or more processors.

Components included in one embodiment can be used in other embodiments in any appropriate combination. For example, any of the various components described herein and/or depicted in the Figures may be combined, interchanged, or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together.

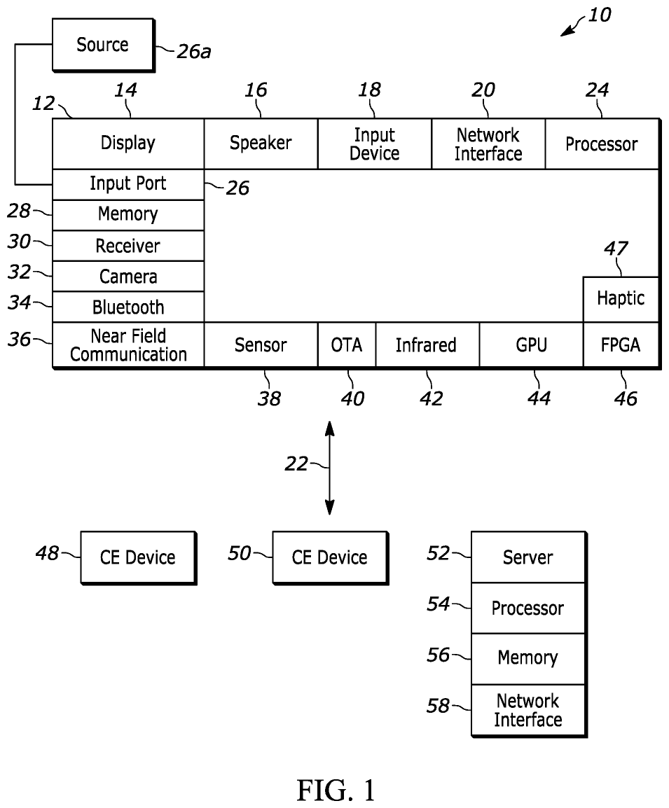

Referring now to FIG. 1, an example system 10 is shown, which may include one or more of the example devices mentioned above and described further below in accordance with present principles. The first of the example devices included in the system 10 is a consumer electronics (CE) device such as an audio video device (AVD) 12 such as but not limited to a theater display system which may be projector-based, or an Internet-enabled TV with a TV tuner (equivalently, set top box controlling a TV). The AVD 12 alternatively may also be a computerized Internet enabled (“smart”) telephone, a tablet computer, a notebook computer, a head-mounted device (HMD) and/or headset such as smart glasses or a VR headset, another wearable computerized device, a computerized Internet-enabled music player, computerized Internet-enabled headphones, a computerized Internet-enabled implantable device such as an implantable skin device, etc. Regardless, it is to be understood that the AVD 12 is configured to undertake present principles (e.g., communicate with other CE devices to undertake present principles, execute the logic described herein, and perform any other functions and/or operations described herein).

Accordingly, to undertake such principles the AVD 12 can be established by some, or all of the components shown. For example, the AVD 12 can include one or more touch-enabled displays 14 that may be implemented by a high definition or ultra-high definition “4K” or higher flat screen. The touch-enabled display(s) 14 may include, for example, a capacitive or resistive touch sensing layer with a grid of electrodes for touch sensing consistent with present principles.

The AVD 12 may also include one or more speakers 16 for outputting audio in accordance with present principles, and at least one additional input device 18 such as an audio receiver/microphone for entering audible commands to the AVD 12 to control the AVD 12. The example AVD 12 may also include one or more network interfaces 20 for communication over at least one network 22 such as the Internet, an WAN, an LAN, etc. under control of one or more processors 24. Thus, the interface 20 may be, without limitation, a Wi-Fi transceiver, which is an example of a wireless computer network interface, such as but not limited to a mesh network transceiver. It is to be understood that the processor 24 controls the AVD 12 to undertake present principles, including the other elements of the AVD 12 described herein such as controlling the display 14 to present images thereon and receiving input therefrom. Furthermore, note the network interface 20 may be a wired or wireless modem or router, or other appropriate interface such as a wireless telephony transceiver, or Wi-Fi transceiver as mentioned above, etc.

In addition to the foregoing, the AVD 12 may also include one or more input and/or output ports 26 such as a high-definition multimedia interface (HDMI) port or a universal serial bus (USB) port to physically connect to another CE device and/or a headphone port to connect headphones to the AVD 12 for presentation of audio from the AVD 12 to a user through the headphones. For example, the input port 26 may be connected via wire or wirelessly to a cable or satellite source 26a of audio video content. Thus, the source 26a may be a separate or integrated set top box, or a satellite receiver. Or the source 26a may be a game console or disk player containing content. The source 26a when implemented as a game console may include some or all of the components described below in relation to the CE device 48.

The AVD 12 may further include one or more computer memories/computer-readable storage media 28 such as disk-based or solid-state storage that are not transitory signals, in some cases embodied in the chassis of the AVD as standalone devices or as a personal video recording device (PVR) or video disk player either internal or external to the chassis of the AVD for playing back AV programs or as removable memory media or the below-described server. Also, in some embodiments, the AVD 12 can include a position or location receiver such as but not limited to a cellphone receiver, GPS receiver and/or altimeter 30 that is configured to receive geographic position information from a satellite or cellphone base station and provide the information to the processor 24 and/or determine an altitude at which the AVD 12 is disposed in conjunction with the processor 24.

Continuing the description of the AVD 12, in some embodiments the AVD 12 may include one or more cameras 32 that may be a thermal imaging camera, a digital camera such as a webcam, an IR sensor, an event-based sensor, and/or a camera integrated into the AVD 12 and controllable by the processor 24 to gather pictures/images and/or video in accordance with present principles. Also included on the AVD 12 may be a Bluetooth® transceiver 34 and other Near Field Communication (NFC) element 36 for communication with other devices using Bluetooth and/or NFC technology, respectively. An example NFC element can be a radio frequency identification (RFID) element.

Further still, the AVD 12 may include one or more auxiliary sensors 38 that provide input to the processor 24. For example, one or more of the auxiliary sensors 38 may include one or more pressure sensors forming a layer of the touch-enabled display 14 itself and may be, without limitation, piezoelectric pressure sensors, capacitive pressure sensors, piezoresistive strain gauges, optical pressure sensors, electromagnetic pressure sensors, etc. Other sensor examples include a pressure sensor, a motion sensor such as an accelerometer, gyroscope, cyclometer, or a magnetic sensor, an infrared (IR) sensor, an optical sensor, a speed and/or cadence sensor, an event-based sensor, a gesture sensor (e.g., for sensing gesture command). The sensor 38 thus may be implemented by one or more motion sensors, such as individual accelerometers, gyroscopes, and magnetometers and/or an inertial measurement unit (IMU) that typically includes a combination of accelerometers, gyroscopes, and magnetometers to determine the location and orientation of the AVD 12 in three dimension or by an event-based sensors such as event detection sensors (EDS). An EDS consistent with the present disclosure provides an output that indicates a change in light intensity sensed by at least one pixel of a light sensing array. For example, if the light sensed by a pixel is decreasing, the output of the EDS may be −1; if it is increasing, the output of the EDS may be a +1. No change in light intensity below a certain threshold may be indicated by an output binary signal of 0.

The AVD 12 may also include an over-the-air TV broadcast port 40 for receiving OTA TV broadcasts providing input to the processor 24. In addition to the foregoing, it is noted that the AVD 12 may also include an infrared (IR) transmitter and/or IR receiver and/or IR transceiver 42 such as an IR data association (IRDA) device. A battery (not shown) may be provided for powering the AVD 12, as may be a kinetic energy harvester that may turn kinetic energy into power to charge the battery and/or power the AVD 12. A graphics processing unit (GPU) 44 and field programmable gated array 46 also may be included. One or more haptics/vibration generators 47 may be provided for generating tactile signals that can be sensed by a person holding or in contact with the device. The haptics generators 47 may thus vibrate all or part of the AVD 12 using an electric motor connected to an off-center and/or off-balanced weight via the motor's rotatable shaft so that the shaft may rotate under control of the motor (which in turn may be controlled by a processor such as the processor 24) to create vibration of various frequencies and/or amplitudes as well as force simulations in various directions.

A light source such as a projector such as an infrared (IR) projector also may be included.

In addition to the AVD 12, the system 10 may include one or more other CE device types. In one example, a first CE device 48 may be a computer game console that can be used to send computer game audio and video to the AVD 12 via commands sent directly to the AVD 12 and/or through the below-described server while a second CE device 50 may include similar components as the first CE device 48. In the example shown, the second CE device 50 may be configured as a computer game controller manipulated by a player or a head-mounted display (HMD) worn by a player. The HMD may include a heads-up transparent or non-transparent display for respectively presenting AR/MR content or VR content (more generally, extended reality (XR) content). The HMD may be configured as a glasses-type display or as a bulkier VR-type display vended by computer game equipment manufacturers.

In the example shown, only two CE devices are shown, it being understood that fewer or greater devices may be used. A device herein may implement some or all of the components shown for the AVD 12. Any of the components shown in the following figures may incorporate some or all of the components shown in the case of the AVD 12.

Now in reference to the afore-mentioned at least one server 52, it includes at least one server processor 54, at least one tangible computer readable storage medium 56 such as disk-based or solid-state storage, and at least one network interface 58 that, under control of the server processor 54, allows for communication with the other illustrated devices over the network 22, and indeed may facilitate communication between servers and client devices in accordance with present principles. Note that the network interface 58 may be, e.g., a wired or wireless modem or router, Wi-Fi transceiver, or other appropriate interface such as, e.g., a wireless telephony transceiver.

Accordingly, in some embodiments the server 52 may be an Internet server or an entire server “farm” and may include and perform “cloud” functions such that the devices of the system 10 may access a “cloud” environment via the server 52 in example embodiments for, e.g., network gaming applications. Or the server 52 may be implemented by one or more game consoles or other computers in the same room as the other devices shown or nearby.

The components shown in the following figures may include some or all components shown in herein. Any user interfaces (UI) described herein may be consolidated and/or expanded, and UI elements may be mixed and matched between UIs.

Present principles may employ various machine learning models, including deep learning models. Machine learning models consistent with present principles may use various algorithms trained in ways that include supervised learning, unsupervised learning, semi-supervised learning, reinforcement learning, feature learning, self-learning, and other forms of learning. Examples of such algorithms, which can be implemented by computer circuitry, include one or more neural networks, such as a convolutional neural network (CNN), a recurrent neural network (RNN), and a type of RNN known as a long short-term memory (LSTM) network. Generative pre-trained transformers (GPTT) also may be used. Support vector machines (SVM) and Bayesian networks also may be considered to be examples of machine learning models. In addition to the types of networks set forth above, models herein may be implemented by classifiers.

As understood herein, performing machine learning may therefore involve accessing and then training a model on training data to enable the model to process further data to make inferences. An artificial neural network/artificial intelligence model trained through machine learning may thus include an input layer, an output layer, and multiple hidden layers in between that that are configured and weighted to make inferences about an appropriate output.

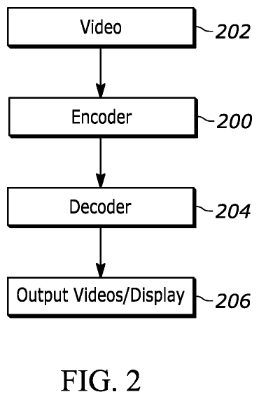

FIG. 2 illustrates a system that includes a video encoder 200 for encoding/compressing videos 202. A video decoder 204 can receive the encoded videos and decode/decompress them into output videos 206.

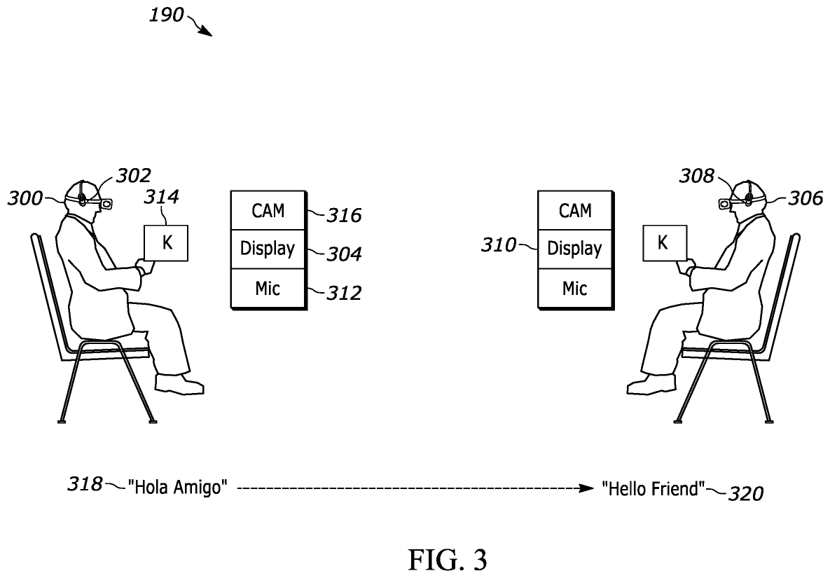

FIG. 3 illustrates a first computer gamer 300 that may wear a headset 302 and/or view a video display 304 to play a computer game that may be a networked game also played by a second computer gamer 306 that may wear a headset 308 and/or view a video display 310 to play the computer game. The first game 300 may input chat to the second gamer 306 either verbally through a microphone 312, which can be converted using speech-to-text techniques to text, and/or by typing the chat in using an input device 314 such as a keyboard. The second gamer 306 may respond to the first gamer 300 using similar techniques. Each game system may also include one or more cameras 316 for imaging the facial expressions of the respective gamers. The display systems shown in FIG. 3 may include some or all of the appropriate computer components shown and described in FIG. 1.

As indicated at 318 in FIG. 3, the chat input by the first gamer 300 can be in a first human language, in the example shown, Spanish. The game system of the first gamer 300 and/or the game system of the second gamer 306 may translate the chat into a second human language as indicated at 320, in this case, English. Note that the translated chat may optionally be converted to audio using text-to-speech techniques.

Translation of chat can introduce latency into the chat. Particularly in the case of fast action computer games, in which the gamers 300, 306 may be team members cooperating with each other, this can be inconvenient. Present principles address the latency issue by predicting the end of a sentence of chat, either prior to translation or after a portion of an incomplete sentence is first translated, which completion can depend on a division of chat between in-game and social chat as described herein.

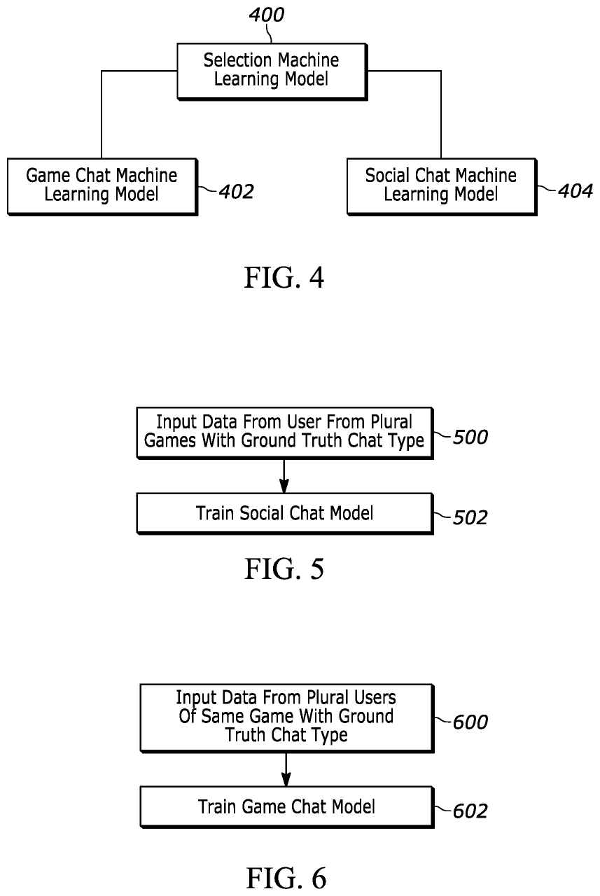

Accordingly, now refer to FIG. 4, which shows a selection ML model 400 configured to select between a game chat ML model 402 and a social chat ML model 404 to be the source of completing a chat sentence between the gamers 300, 306 shown in FIG. 3, for example. Note that as chat is being input, all three models may receive the chat and begin processing the chat. However, while it is the task of the game chat and social chat models 402, 404 to predict the completion of the chat, the selection ML model 400 does not need to wait for a complete chat sentence to be input before selecting which of the other models 402, 404 will be used to predict the complete sentence of the chat.

FIG. 5 illustrates that the social chat model 404 may receive, at state 500, an input training set of chat sentences input by users of plural computer games in general with indications of ground truth chat type, i.e., whether each item in the training set is related to a computer game or is not related to a computer game (in other words, is social chat that does not involve game context). The model is trained on the data at state 502.

On the other hand, the training set of data input at state 600 in FIG. 6 to train the game chat model at state 602 may include chat data of plural users of the same game being played by the gamers in FIG. 3, along with ground truth indication of the type of chat each chat is.

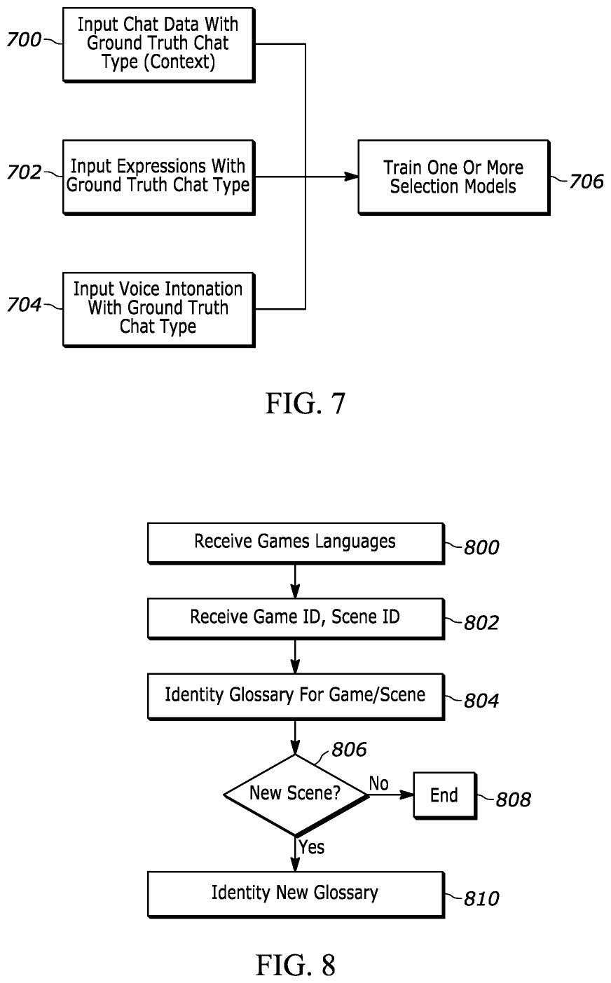

In contrast, FIG. 7 illustrates that at least one and in the example shown three sets of training data 700, 702, 704 may be input to the selection model (which itself may include plural ML models) to train the selection model at state 706. In the example shown, chat data with ground truth chat type (game or social) 700 is input. Also, facial expressions along with ground truth chat type associated with those expressions 702 also is used to train the model. If desired, audible information such as voice intonation along with ground truth chat type associated with each intonation 704 may be used to train the selection model. Furthermore, the selection model may maintain history of decisions, so that, for example, if it determines that a first chat sentence portion is classified as social, an immediately following sentence portion may also be so classified.

The selection model further may be trained to recognize game context to classify chat. For example, chat input during high activity game segments may be more likely to be game chat than social chat, whereas chat input during lull times in the game may be more likely to be social chat. Game context may be inferred by motion vectors from the game engine, direct input from the game engine indicating context, and scene recognition applied to video of the game. The intonation/facial expression training data of FIG. 7 also may be used to train the selection model on context, with excited intonation or excited facial expression of a gamer, for example, indicating that the chat is related to the game.

Any of the models shown herein may be trained to translate the chat. For example, the selection model may be trained to translate the chat. Or, a separate model may be used for translation.

Turn now to FIG. 8 which shows logic that may be implemented by any one or more processors described herein. Commencing at state 800, the respective languages of two gamers who wish to chat with each other as they play a computer game via a network for example are identified, such as by direct identification by each gamer of his own language or by voice analysis of words spoken or typed by each gamer or by use of gamer profiles or other means. The identification of the game they are playing along with the identification of the current scene may be received at state 802.

Using the game (and if desired scene) identifications, a glossary is identified at state 804. As used herein, a glossary is a list of terms in a specific computer game and may be specific to individual scenes in the game, with accompanying translations in one or more languages. Note that some terms of a game may be unique to the game such as coined names or proper nouns and thus may not require translation, and in such instances the glossary may indicate that such terms are passed along unchanged.

State 806 indicates that in embodiments which do not employ a single glossary for the entire game but instead employ glossaries keyed to terms in each scene, if a new scene is not detected the logic ends at state 808 with the selection of the glossary at state 804. However, upon scene change a new glossary may be identified and accessed at state 810.

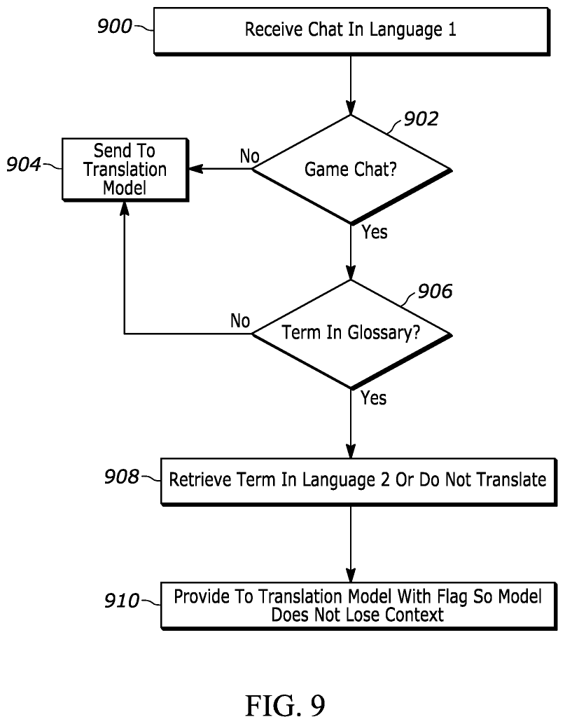

Turn now to FIG. 9. Commencing at state 900, during gameplay chat is received in a first language. The chat may be received from an input device of the sender, e.g., from a microphone (and converted to text) or from a keyboard as text input. Signing may be used to input chat in which case the input device is a camera and sign recognition is performed on images from the camera to convert the signing to text.

Proceeding to state 902, it is determined whether the chat pertains to the game, or is simple social chat unrelated to the game, consistent with disclosure above. If the chat is not game chat it may be sent to a ML model-implemented translation engine at state 904 for translating the chat into a second language, i.e., that of the second gamer identified at state 80 in FIG. 8.

On the other hand, if it is determined that the chat pertains to the game being played the logic flows from state 902 to state 906 to determine if an entry for each successive term exists in the glossary. If no entry exists in the glossary for a term, that term is sent to the translation engine at state 904. However, if a term is found in the glossary, the glossary is accessed to return a corresponding term in the second language at state 908. In the case of coined names or proper nouns or other terms that do not require translation, the glossary may indicate that such terms are passed along unchanged. The terms translated by the translation engine from state 904 and the terms looked up from the glossary at state 908 are sent via a network in correct temporal order to a recipient's output device, such as a video display and/or speaker, for presentation of the chat in the second language to the recipient.

State 910 indicates that terms looked up from the glossary may be provided to the translation engine to enable the engine to maintain context. The terms from the glossary may be provided with a flag indicating that they are not to be translated but that they are to be used only as necessary to maintain context for translating other terms at state 904. Or, the terms from the glossary itself may not be provided to the translation engine but only an indication of the grammatical part of speech the terms are for use in maintaining context.

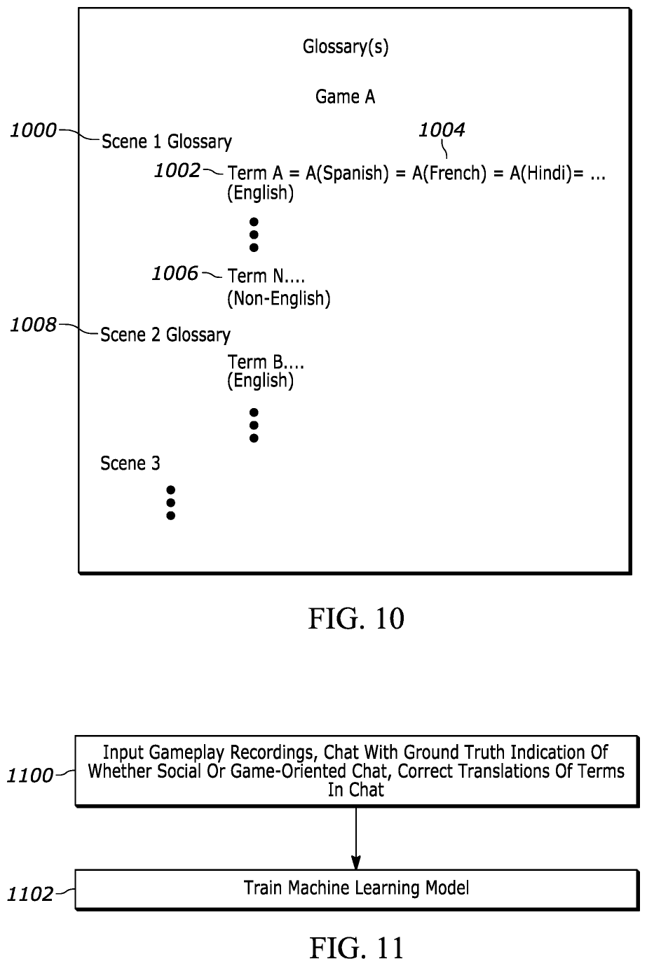

FIG. 10 illustrates an example “at least one” glossary, in the example shown, a set of glossaries, one for each scene of a computer game. A glossary 1000 for a first scene may include a first term “A” 1002 in English that occurs in the first scene with a set of corresponding terms 1004 in multiple other languages. The first glossary 1000 also may include an Nth term 1006 that occurs in the first scene and that may not be an English term per se but a coined term or proper noun, and the glossary indicates that the term is to be passed on unchanged.

A second glossary 1008 and subsequent glossaries may be provided, one glossary for each scene of the game and containing terms used in that scene.

FIG. 11 illustrates that a ML model may be trained to create a glossary by inputting a training set of data at state 1100 and training the model on the data at state 1102. The training set may include, e.g., gameplay recordings of chat with ground truth indications of game and scene and whether the chat is social or game-oriented. The training set also may include ground truth translations of terms in the game scene.

While particular techniques are herein shown and described in detail, it is to be understood that the subject matter which is encompassed by the present application is limited only by the claims.

What is claimed is:

1. An apparatus comprising:
at least one processor assembly configured to:
receive, from a sender input device, chat in a first language;
under at least a first condition, responsive to a first term in the chat being in a glossary associated with a computer game, look up a term in a second language from the glossary corresponding to the first term;
responsive to a second term in the chat not being in the glossary, provide the second term to a translation engine to output a term in the second language corresponding to the second term; and
send the term in the second language from the glossary corresponding to the first term and the term in the second language corresponding to the second term to a recipient output device for presentation thereof.

2. The apparatus of claim 1, wherein the first condition comprises the chat pertaining to the computer game associated with the glossary, and the processor assembly is configured to:
not look up the first term in the glossary responsive to the chat not pertaining to the computer game associated with the glossary and provide the first term to the translation engine.

3. The apparatus of claim 1, wherein the processor assembly is configured to:
under at least the first condition, responsive to a third term in the chat being in the glossary and being a non-language term or proper noun associated with the computer game, send the third term unchanged to the recipient output device.

4. The apparatus of claim 1, wherein the recipient output device and sender input device communicate with each other over a wide area computer network.

5. The apparatus of claim 1, wherein the processor assembly is configured to:
provide the term in the second language from the glossary corresponding to the first term to the translation engine, or provide an indication of the part of speech of the term in the second language from the glossary corresponding to the first term to the translation engine, or both provide the term in the second language from the glossary corresponding to the first term to the translation engine and provide an indication of the part of speech of the term in the second language from the glossary corresponding to the first term to the translation engine.

6. The apparatus of claim 5, wherein the processor assembly is configured to execute the translation engine to maintain context using the term in the second language from the glossary corresponding to the first term to the translation engine and/or the indication of the part of speech of the term in the second language from the glossary corresponding to the first term.

7. The apparatus of claim 1, wherein the processor assembly is configured to identify the first and second languages.

8. The apparatus of claim 1, wherein the glossary is a first glossary and the chat is received during a first scene of the computer game, and the processor assembly is configured to use a second glossary responsive to the computer game presenting a second scene, the first glossary being associated with terms in the first scene and the second glossary being associated with terms in the second scene.

9. An apparatus comprising:
at least one computer medium that is not a transitory signal and that comprises instructions executable by at least one processor assembly to:
translate first terms in chat in a first language and input during play of a computer game to second terms in a second language using a translation engine;
look up third terms in the chat in the first language using a glossary to correlate the third terms to fourth terms in the second language; and
send the second and fourth terms on an output device for presentation thereof.

10. The apparatus of claim 9, wherein the instructions are executable to look up the third terms only responsive to determining that the chat pertains to the computer game.

11. The apparatus of claim 9, wherein the instructions are executable to:
responsive to a fifth term in the chat being in the glossary and being a non-language term or proper noun associated with the computer game, send the fifth term unchanged to the output device.

12. The apparatus of claim 9, wherein the instructions are executable to:
provide the second term or an indication of the part of speech of the second term or both the second term and the indication of the part of speech of the second term to the translation engine.

13. The apparatus of claim 12, wherein the instructions are executable to execute the translation engine to maintain context using the second term and/or the indication of the part of speech of the second term.

14. The apparatus of claim 9, wherein the instructions are executable to identify the first and second languages.

15. The apparatus of claim 9, wherein the glossary is a first glossary and the chat is received during a first scene of the computer game, and the instructions are executable to use a second glossary responsive to the computer game presenting a second scene, the first glossary being associated with terms in the first scene and the second glossary being associated with terms in the second scene.

16. A method comprising:
receiving chat during play of a computer game and input by means of at least one input device, the chat being in a first language;
translating first terms in the chat to terms in a second language using a translation engine;
using second terms in the chat to look up terms in the second language using at least one glossary; and
sending the terms in the second language obtained from the translation engine and the glossary to at least one output device.

17. The method of claim 16, comprising looking up terms using the glossary only responsive to determining that the chat pertains to the computer game.

18. The method of claim 16, comprising:
responsive to a third term in the chat being in the glossary and being a non-language term or proper noun associated with the computer game, sending the third term unchanged to the output device.

19. The method of claim 16, comprising:
providing the terms looked up using the glossary or indications of the parts of speech of the terms looked up using the glossary or both the terms looked up using the glossary and indications of the parts of speech of the terms looked up using the glossary to the translation engine to execute enable the translation engine to maintain context.

20. The method of claim 16, comprising using a first glossary to look up terms during a first scene of the computer game and using a second glossary to look up terms during a second scene of the computer game.
